(19) United States
(12) Patent Application Publication
(10) Pub. No.: US 2007/0000411 A1
(43) Pub. Date: Jan. 4, 2007

(54) Method for the manufacture of a pastel-white, highly opaque micro-particle rutile pigment, the therewith obtained rutile pigment and its utilization

(76) Inventors: Rainer Heubach, Grossgmain (AT); Reinhard Marx, Nerja (DE)

Correspondence Address: Scott A. McCollister, Esq.;Fay, Sharpe, Fagan, Minnich & McKee, LLP, Seventh Floor, 1100 Superior Avenue, Cleveland, OH, 44114-2579, US

(21) Appl. No.: 11/361,024

(22) Filed: Feb. 23, 2006

(30) Foreign Application Priority Data
Feb. 25, 2005 (DE) 10 2005 009 233.0
May 12, 2005 (DE) 10 2005 022 076.2

(51) Int. Cl. C09C 1/36

(52) U.S. Cl. 106/436; 106/438; 106/439; 106/441; 106/442; 106/449; 106/440; 106/443; 106/444; 423/610

(57) ABSTRACT

Described is a method for the manufacture of a pastel-white, highly opaque, micro-particle rutile pigment from a crude rutile, synrutile or from a slag-like rutile-type precursor characteristic for traditional titanium dioxide production from processing ilmenite into titanium dioxide. This method distinguishes itself in that the starter material in form of the crude rutile, synrutile or the slag-like rutile-type precursor is ground down in several stages in high efficiency mills without leaving any significant metallic fines, to a particle size of approximately 200 to 600 nm, whereby initially a dry pre-grinding step is performed and thereafter with high recorded grinding output a wet grinding step is performed in a final grinding phase. The ground-down product is dried and the obtained rutile pigment is calcinated in finely distributed form at temperatures between 790 and 1050° C. The invention thus also concerns-a pastel-white, micro-particle and highly opaque rutile pigment attainable according to this method with reduced grinding-stable photo-activity and a grain size distribution of particle diameters ranging between 150 and 100 nm and with mono- or oligo-modal frequency distribution with a principal maximum of the distribution curve between 200 and 600 nm. It presents a particularly fine brightness, purity of color and covering capability with concurrently to a minimum reduced photo-activity and it is suitable for being beneficially worked into polymer materials, construction materials, ceramic lamination materials, papers and pressed laminates, varnishes, paints and print colors.

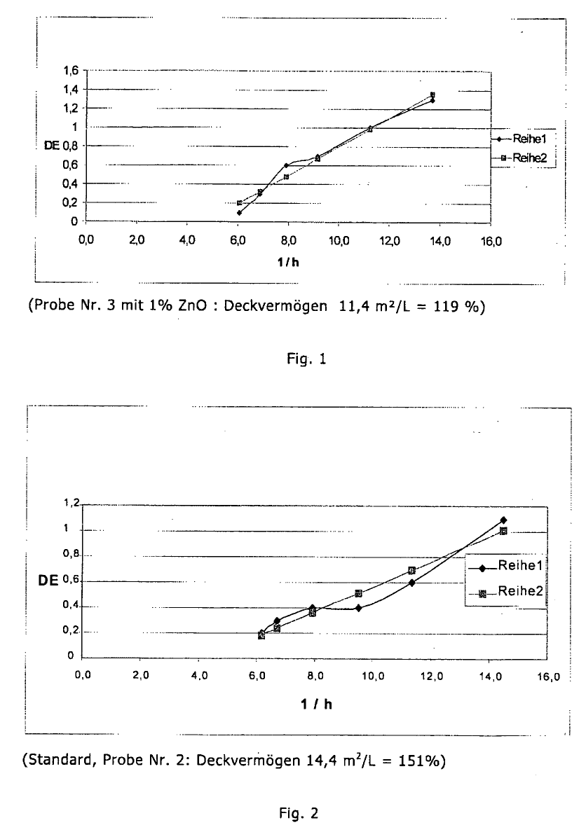

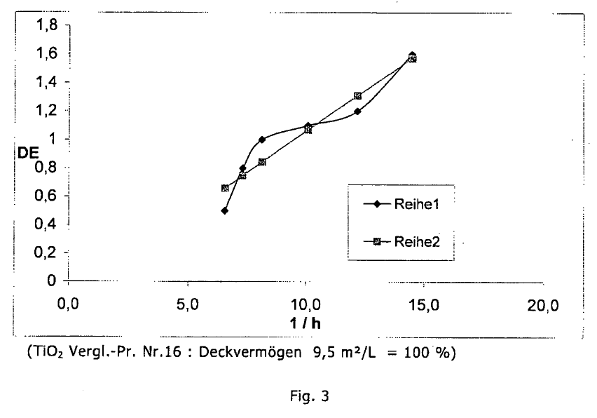

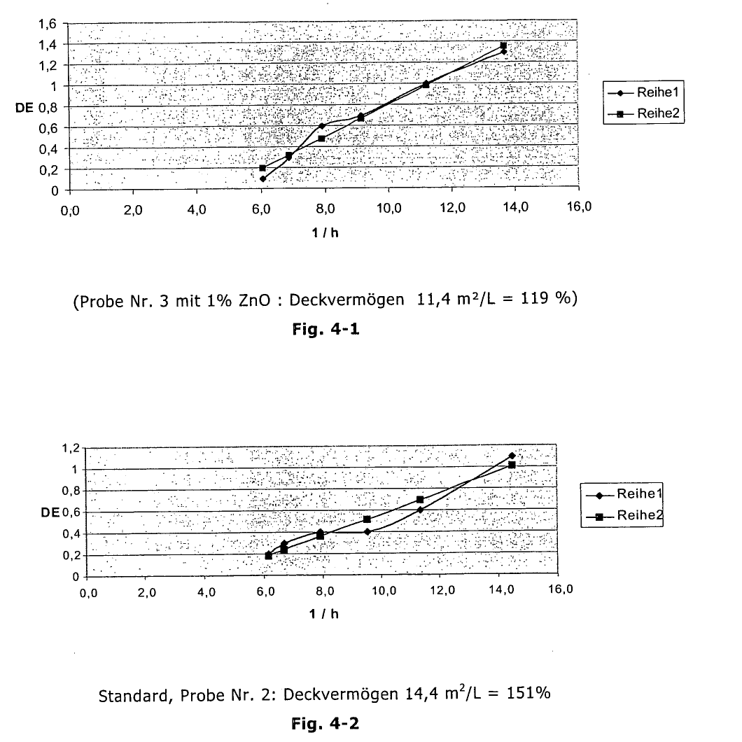

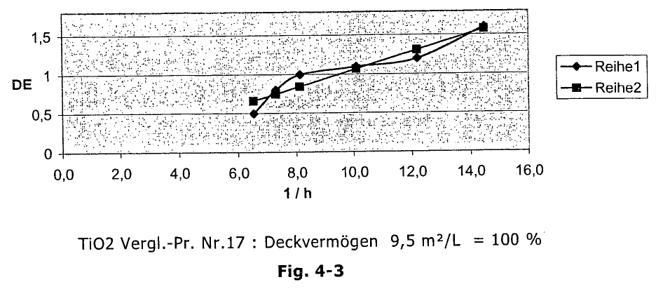

### BACKGROUND

The invention concerns a method for manufacture of a pastel-white, highly opaque micro-particle rutile pigment from crude rutile, synrutile or from a for the production of titanium dioxide characteristic slag-like rutile-type raw material originating from processing ilmenite into titanium dioxide, a rutile pigment obtainable according to said method as well as its utilization. In addition, the invention concerns a thereby targeted low-doped titanium oxide pigment which presents highly reduced photo-activity and which, instead of being manufactured from classically produced titanium dioxide, is made by means of high-efficiency micro-grinding and additional supplemental doping from its rutilistic raw materials or interim processing products, such as natural rutile or synthetic rutile (“synrutile”), without requiring a finishing micro-grinding step.

### DETAILED DESCRIPTION

The modern representation process for rutile pigments is the chloride method. One learns from the description, among others, in Buxbaum G. (Publishers): Industrial Inorganic Pigments” (3^{rd} edition, Weinheim: VCH-Wiley, 2004) Section 2.1.2.2 and 2.1.3.2 and also Winkler, J. “Titanium Dioxide” (Hannover: Vincentz, 2003) Section 3.1 and 3.3 that an already processed TiO₂ raffinate is needed, the so-called “synrutile. It is obtained, among others, from ilmenite, in that by means of hot hydrochloric extraction iron and other accompanying substances are removed from the “synrutile, so that the “synrutile” remains with a TiO₂-contents of 90 to 99% TiO₂. In difference to titanium dioxide pigments, “synrutiles”, sorel- or rutile slags, which are ground up under normal process conditions, do not present any pigment qualities. This is due, on the one hand, to their origin-dependent, imperfect product constancy resulting from a multitude of procedural dependencies, so that they present dark color shades ranging between gray and brown-gray. Secondly, their average grain size of 0.1 to 3 mm precludes utilization as pigment. Undoubtedly, a pigment on said basis can also be “emulated” by thermal diffusion reaction of approximately 8% zinc ferrite and 92% titanium dioxide known from disclosure specification DE 3202158 A1, which results in an iron- and zinc-containing rutile, but the energy-intensive representation process which consists of multi-stage syntheses lacks economic perspective. The former product also detrimentally distinguishes itself when being worked for example into a PVC matrix by the appearance on the surface of a reactive iron residue, which would have to be counter-acted by means of subsequent stabilization processes—the one here claimed would also be suitable.

The present invention, instead, is meant to avoid the cumbersome raw material transformation work.

The economic significance of a slightly yellowish, brownish or reddish tinted “pastel” white titanium dioxide represents a small share of titanium dioxide tonnage per year, having, however, the significant benefit that substantially added value would already be obtained in that one can create such pigment quality directly from the raw material without having to employ a by-path via raffination of TiCl₄ and subsequent expensive synthesis steps. Utilization would specifically aim at manufacture of color shades in the range of color applications under the standard designation “RAL 1000, 1001, 1002, 1013, 1014, 1015, 9001, 9018” (and/or equivalents of color shades Pantone® 1205, 1215, 7401, 7499, 7500, 7501, 7502, 7506, 7527”) without costly readjustment work.

Even with top conventional ball- and jet-grinding of crude rutile, one can only obtain difficult to reproduce and dirty color tones, which, in addition, show with UV radiation a strong tendency toward photo-catalytic decomposition of the application matrix, an effect which is to be more closely defined under the concept “photo-activity”.

The standard solid matter diffusion reactions (Buxbaum, G.: Industrial Inorganic Pigments”, 2^{nd} edition, Weinheim: Wiley-VCH 1998, Pages 43-70 and 99-105; Smith, H. M.: High Performance Pigments”. Weinheim: Wiley-VCH 2002, Pages 41-73) during calcinations for producing mixed phase oxide pigments lead, on the one hand, to a reduction of lattice vacancies, but they also result in color-providing embedment of foreign atoms in the rutile lattice. Such process very significantly reduces in its effect the photo-activity of the titanium dioxide. The question is left open as to whether and if the energy levels of the lattice electrons are restricted or their distances are expanded up to inactivity. It is known, for example [Literature: Gesenhues, U., Rentschler, T.: “Crystal Growth and Defect Structure of Al³⁺-doped rutile”, J. Solid State Chem. 142 (1999) 210-218; also: Gesenhues, U.: “Doping of TiO₂ pigments by Al³⁺n, Solid State Ionics 101-103 (1997) 1171-1180], that aluminum doping causes a reduction in photo-activity. Although furnishing the rutile lattice with foreign ions can take place in different ways (diffusion from subsequent addition, diffusion from applied gel coating, addition to TiCl₄ combustion process, as in PGP US-A 2004/0258610, coinciding decomposition of titanium tetrachloride in the presence of reactive compounds of doping elements as described, for example, in Patent Specification U.S. Pat. No. B-6,835,455)—the results are comparable. In contrast thereto, surface coatings of pigments are less effective for limitation of photo-activity; they should, however, not be neglected for also application-appropriate after-treatment of the invention-specific pigments.

Further background information and the supporting state of the art are described in detail in the book by J. Winkler “Titanium Dioxide” (Hannover: Vincentz 2003).

The invention, therefore, was based on the object of beneficial further development of the initially indicated state of the art, in particular the suggestion of how to produce, from a “synrutile” of fluctuating composition, a constant slightly pure yellowish or reddish-brown tinted titanium dioxide pigment quality, which possesses excellent covering properties, high brilliance as well as greatly reduced photo-activity. In addition, with respect to titanium dioxide, the goal is to facilitate fines-resistant processing and low-distorsion pigmentation of polymer raw materials.

The process is to be carried out subject to extensive removal of iron.

According to the invention, said object is solved via a method of the initially described kind in that the starter material in form of crude rutile, synrutile or the slag-like rutile-type precursor material is ground down in several stages in high efficiency mills, which do not leave behind any metallic fines or essentially no metallic fines, to a particle size of approximately 150 to 600 nm, whereby initially a dry preliminary grinding step is carried out and subsequently with high recorded grinding output in a final phase, a wet grinding step is performed. The ground-up product is dried and the obtained rutile pigment is calcinated in finely distributed form at 790 to 1050° C.

The method according to the invention permits a multitude of beneficial embodiments:

The rutile pigment obtained according to the invention is preferably subjected to desagglomeration. Additionally, it is appropriate that the starter material is ground down in high efficiency mills, which do not leave behind any staining or coloring fines, to a degree of fineness having a medium grain diameter which maximally lies 10% below the medium grain fineness of the final product. It is also appropriate that during wet grinding for doping purposes a thermally decomposable reagent is added totally or partially as saline solution or as suspension, having no solid or liquid residues, with the exception of the doping elements. It is further considered preferential that the crude rutile in homogenized mixture with salts, hydroxides and/or organic complex structures of its doping elements is roasted over sufficient time and at sufficient temperature for the diffusion process to take place.

With respect to the last named special embodiments, it is particularly beneficial that one or several of the doping elements are applied prior to roasting as one or several particle coatings on the surface of the imprinting pigment in a chemical precipitation step.

It is generally accepted within the scope of the invention that it is appropriate if the doping elements tin, ceric, circonium, zinc, antimony, aluminum, boron, gallium, calcium, phosphorous, silicon and/or germanium are applied singly or in combination of several. Moreover, it is appropriate that the doping elements are employed in such quantity that individually they do not amount to more than 10% by weight, in particular not more than 4% by weight of the final product and/or the following are employed as staining or color-intensifying as well as valency equalizing doping elements nickel, niobium, chromium, vanadium, phosphorous, molybdenum, silicon, gallium, antimony and/or tungsten.

It is preferred that in the processing of synrutile as starter material, the following are employed, either singly or in targeted combination as deactivating and/or stabilizing substances: oxides, hydroxides, carbonates, nitrates, fluorides and/or sulfates of especially zink, tin, calcium, aluminum, circonium, ceric, boron and/or silicon. In this embodiment as well as in the previously described other embodiments of the invention, it is of benefit if the doping means are applied in finely distributed and/or suspended or in dissolved format and/or the doping elements are applied as gel coating on the surfaces of the rutile particles.

Furthermore, it is appropriate within the scope of the invention to employ for producing a rutile pigment from synrutile, 0.1 to 10% by weight of doping mass parts in order to neutralize the color of the iron parts. The addressed calcinations of the obtained rutile pigment in finely distributed form at 790 to 1050° C. can be beneficially designed in that it is performed in a time frame of 10 to 270 minutes, in particular of 15 to 90 minutes.

Solution component of the present invention is also a pastel-white, effectively covering, finely grained rutile pigment attainable according to the invention-specific method and/or in particular according to its beneficial embodiments as described above, having reduced, grinding-stable photo-activity and a granular size distribution with particle diameters ranging between 150 and 2000 nm, preferably between 250 and 1000 nm and in particular between 200 and 1000 nm and with a mono- or oligo-modal frequency distribution with principal maximum between 300 and 600 nm.

Consequently, the invention also concerns a fine-grained, yellowish, reddish or brownish- tinted, almost white, highly opaque and doped rutile pigment on basis of crude rutile qualities, with a processing-stable reduced photo-activity and a grain size distribution with particle diameters between 150 and 2000 nm, in particular between 200 and 1000 nm and with mono-, bi-, tri- or multi-modal frequency distribution, a principal maximum between 300 and 600 nm. The characterization “yellowish, reddish or brownish tinted, almost white” shall mean according to the meaning of the invention “pastel white”, made clear by way of example via the above named color standards.

In addition, it is appropriate that it is doped in the rutile lattice with soluble and diffusing metal ions, which photo-chemically deactivate the rutile. In regard to the already earlier indicated object, it is particularly beneficial if the iron contents amounts to less than 5% by weight, in particular 0.5 to 5% by weight. The several times mentioned doping elements are contained in the invention-specific rutile pigment preferably in form of tin, ceric, circonium, zinc, antimony, aluminum, boron, gallium, calcium, phosphorous, silicon, and/or germanium.

Moreover, beneficial utilization of the indicated rutile pigment is also attributable to the inventive concept, and it can be employed in construction material, ceramic coatings, polymer raw materials, paper, paints, varnishes and printing paints.

The inventors during their preliminary tests found out, quite surprisingly, that when using analogue calcining methods, ground crude rutile or “synrutile” were notably limited in photo-activity, but overall not yet sufficient. The photo-activity, however, could still be further reduced if an addition was doped-in of foreign elements in form of oxides, hydroxides or salts in surprisingly small quantities, whereby the residual iron, initially having strong staining capability, eventually oxidizes during calcining and is likewise greatly lightened in its coloring effect by installation into the rutile host lattice; furthermore, when the latter obtained pigment is being worked into PVC materials, it is no longer available for interfering reciprocal effects with the matrix. In comparison with mixed phase oxides, the treatment of the finish-ground pigment can be undertaken at relative low temperatures, without the material becoming more coarse, which is another important benefit of the method according to the invention.

In the following, the invention will be presented in detail using various leading parameters:

Grinding procedure: The invention-specific method is initially preceded by a grinding process in order to grind down the crude rutile material in one or several phases to attain a high degree of fineness which corresponds to the final product. To that end, high efficient mills are preferably employed, for example, which do not leave any metallic abrasive residues, which would influence, in uncontrolled fashion, the additional steps. Within the scope of the research work, it turned out that significant benefits are being gained if at least the last of these grinding phases is a high efficiency wet grinding step. In such type of intensive wet grinding it is possible to already add part or all of the oxide or salt-of the doping elements, either in sludge form or in dissolved form, but this is to be decided depending upon the respectively selected type of doping, since agglomerations and reduced output entries into the grinding product are noted and/or a non-reproducible portion of the doping substances can subsequently be lost, so that their activity, on a case by case basis, is no longer sufficient in order to obtain a doping level that would benefit the object of the invention. It is possible to use the pure salt solution as grinding liquid and to dry the wet grinding product, after having been ground down to avoid caking, but also under avoidance of dripping losses.

The topology of the elements of the drying facility is not important, initially. It is possible to successfully charge this “grinding suspension” into a rotary pipe furnace and continuously work with it by integrating drying and calcining into one apparatus. In our research it proved beneficial, however, to have grinding, drying and calcining take place separately.

Particle size: By nature, it is particularly beneficial for acceleration of the calcining reaction to have the largest possible surface, to employ raw material which has already been ground down to grain sizes ranging approximately between 100 and 200 nm, preferably ground down to an average grain diameter between 200 and 1000 nm. The particle size does not substantially increase during calcining. This produces and/or retains the excellent cover quality of the invention-specific pigment. The product merely needs to be subjected, following calcining, to an easily executed desagglomeration step. In contrast to the state of the art, the grain size has in essence already been established prior to the reaction.

Deactivating or stabilizing substances: Even though in practical application one uses the term “stabilization” according to the meaning of photo-activity. However, strictly speaking, according to the state of the art, all tests involve deactivation, in most instances by means of surface coating. The rutile lattice itself remains unchanged during the catalyzing reactions which result in decomposition of the pigment environment. For purposes of deactivation, all mineral-forming elements of the periodic system are in principle employable, to the extent that they do not burden the rutile lattice with inadmissible expansions via its ion radii and to the extent that based on the selection of suitable combinations of elements and imperfections it is possible to maintain the charge balance of titanium dioxide (Principle of “Isomorph Substitution”; Basis of chemistry of CIC pigments according to above named state of the art). With “synrutile” as basis for production of “pastel-white pigments this is specifically successful due to the use of oxides, hydroxides, carbonates, nitrates, fluorides or sulfates, preferably due to use of zinc, tin, calcium, aluminum,-circonium, ceric, boron and silicon, either singly or in targeted combination.

Doping, however, can also further be refined for production of classic CIC pigments, with the resulting traditional colors depending upon the [respective] elements. Transitions to that end are fluid. As a result, within a certain framework, it is possible to expand the raw material basis for classical mixed phase oxide pigments.

Addition of Doping Substances: The addition of doping substances is likewise properly done in finely distributed, suspended or dissolved form, so that there exist omnipresence of reaction partners and short diffusion paths. To that end, application of doping elements as gel coating on the surfaces of the rutile particles has proven itself, among others, similar to the methods generally known from the stabilizing coating of pigments.

During the course of the tests, the salts of amphoteric doping metal were also employed, such as aluminates and zincates. The therewith connected alkali entry, however, results in tendency of the primary rutile particles to stick together, bake together and to finally sinter or roast. Precipitation at the site, for example of aluminum-oxide-hydrate by reaction of aluminum sulfate with sodium aluminate requires a washing step after grinding, due to the formation of soluble neutral salts, which are of no use for later doping.

This would make the process unnecessarily expensive. Coating before grinding of particles would not make sense.

Doping Level: For the manufacture of “pastel-white” “synrutile”-pigments approximately 0.1% to 10% by weight of doping mass shares are preferably used in order to color-neutralize the iron shares by way of “basic doping” and to chemically stabilize them as well as to minimize photo-activity under UV radiation. It is particularly preferred to work in the range between 0.5 and 5% by weight.

Type of Furnace Construction: Special rotary pipe furnaces with a tempering zone and defined oxygen supply zone behind the reaction pipe have proven themselves according to EP 325987 and EP 325988; however, it is possible to maximize the ability of reproducing the results if temperature-programmed hood-type furnaces or muffle furnaces are employed. For subsequent calcination in order to re-supply of oxygen, a fluidized bed furnace has proven itself as practical. The invention is therefore assumed to be primarily independent of furnace architecture.

Temperature: Calcination of the synrutile” in the presence of mineralizing, invention-specific doping and color-providing additions is in keeping with the course of action of the state of the art of mixed phase metal oxide pigments. In the event that nickel, niobium, chrome, vanadium, phosphorus, molybdenum, silicon, gallium, antimony, and/or tungsten are employed as color-providing and color-intensifying as well as

valency-equalizing doping elements, it is possible to establish here a calcination temperature between 800 and 1300° C. In general, however, the following applies,

particularly if these color-providing and color-intensifying and valency-equalizing doping elements are not included, namely to have the calcination temperatures range between approximately 500 and 1100° C. However, for purposes of the invention and for solving the assigned objective, it is highly preferred to set the calcination temperatures to between 790 to 1050° C. in order to favorably influence the energy balance of the process as well as the grain construction of the product.

Reaction Times: The same as with respect to the production of mixed phase metal oxide pigments according to the above cited state of the art, a longer dwelling time in the calcination zone means a more complete reaction course, whereby one seeks to attain in actual practice an optimization between energy consumption, product quality and production volume, basically being dependent on selection of temperature and composition of mixture, but in the invention-specific method a reaction time of 10 to 270 minutes, preferably 15 to 90 minutes is found to be adequate. Too long a dwelling time and/or too high a temperature can lead to the result that the reaction product—due to remaining salt rests—will start to melt locally and becomes sintered together, which, in turn, has a counter-productive effect on the completeness of the reaction with the doping substances as well as on the once more increasing grain size; both conditions have the result that after the coarse and fine grinding according to the process, one can again observe photo-activity, which cannot be designed in replicable fashion, the same as the color properties.

Surprisingly, the calcination of crude rutile pigments under the named conditions does not only lead to greatly reduced photo-activity, but also lightens with minimal quantities of non-color-providing doping elements, such as for example aluminum, zinc, calcium, ceric or tin, the resulting pigment-like substances from gray to a pale whitish, but pure yellow shade with a slight hue of red.

In beneficial fashion, this can be observed in equal measure with respect to “synrutile” raw materials, which contain highly fluctuating residual iron contents ranging between 0.3 to 10% by weight, in particular, however, between 0.5 to 5% by weight from the processing of ilmenite. This enlarges significantly the raw material basis which is available for the process. The low-dose doping, but not the coating (for example according to PGP US-A-2004/0258610 and US 2004/0250735, nor, however, “heavy” coatings according to U.S. Pat. No. 4,375,373, U.S. Pat. No. 4,328,040, U.S. Pat. No. 4,125,412, U.S. Pat. No. 4,447,271, GB 2242420, GB 2252551, GB 2253893, EP 78633, EP 409999879) of the ground-down synrutile represents a path in order to anchor in stable fashion the iron contents in the lattice of the rutile together with, for example, zinc, ceric, aluminum, calcium, or tin, and to largely color-neutralize same and/or to bring it to a constructive function, whereby the invention-specifically introduced “artificial” doping elements may stochiometrically also be in the minority vis-a-vis the iron. X-ray fraction tests produced no deviation from rutile pattern, only minor changes in the lattice constants; a feared formation of perow-skit-, anatas-, ilmenite, or spinell-analogue crystal-phases cannot be ascertained, starting with genuine doping or “fixed solution” in the rutile host lattice. The by-path doping according to DE 3202158 also leads to an analogue rutile, which, however, by means of establishing the components on the surface, contains partially reactive iron portions, and can, therefore, be considered as sub-optimally doped according to the meaning of this invention.

It is of further benefit that the obtained doped synrutile and also the thereby factually attainable “pastel”-white rutile mixed-phase oxide pigment with lattice-bound “iron residue” can flawlessly be worked into PVC matrices. At the same time, one can observe greatly reduced photo-activity of obtained pigments, both in the rapid test according to Dupont (described in: Braun, J. H.: “TiO₂'s Contribution to the Durability and Degradation of Paint Film—II. Prediction of Catalytic Activity”, J. Coatings Technology 62 (1990) No. 785, 37-421 hereinafter called Dupont Test) as well as with simple 180 W-/360 nm-UV exposure of a color coating with ‘HANAU-FLUOTESTER 5261’. A previously employed test with methyl-viologues in alcohol-water suspensions proved itself as too dangerous and dispersion-affected. Exposure to artificial weathering in ATLAS-1200 CPS “Xeno-tester” in accordance with DIN ISO 11341:1998 with radiated efficiency density of 55 W/m2, UV-filter 3×Suprax; wet/dry-cycle 18:102 minutes confirmed these findings also in actual practice in mixture with organic coloring substances (Table 6).

In a subsequent grinding step under iron-free conditions, another “whitening” occurred, but in the Dupont Test one did not observe any “dirty hue” nor any significant photo-activity under UV. This is considered as a definite indication that the suppression of photo-activity did not take place due to coating or surface-near installation of a foreign atom into the rutile lattice, but as a result of transitional doping within the course of solid matter diffusion reaction, analogue to a mixed phase oxide pigment, whereby, at the same time, the color-providing effect as well as the reactivity of the iron residue were limited to a constant minimum.

The end product of said sketched invention-specific method has pigment character with decomposing catalytic effects upon the matrix of mixed additions of organic pigments and presents high cover potency, with yellow-white to brownish-white color tint and an almost randomly adjustable medium grain size of only approximately 300 nm, for example, whereby the procedural gravity center of the grinding activity can beneficially be placed before the doping or calcination step, since by way of further benefit of the invention-specific process there does not take place any significant re-agglomeration or coarsening via sintering during calcination.

In addition to the works by Hund et al—(cited in Buxbaum, G.: “Industrial Inorganic Pigments”, 2^{nd} edition, Weinheim; Wiley-VCh 1998, Pages 43-70 and 99-105; Smith, H. M.: “High Performance Pigments”, Weinheim: Wiley 2002, Pages 41-73)—of the known color-providing doping with nickel, tungsten or chrome together with antimony, the likewise color-lightening, but nevertheless color-influencing effect of normally in oxygen-coordination non-coloring elements, such as zinc, calcium, ceric or tin in the doping was noted with surprise. The transitory doping of the particles resulted from continued non-ascertained photo-activity after further grinding and also from the coloration; it could be seen, for example, in the chemical analysis in that with concentrated acids only maximally 50% by weight of the installed elements could be dissolved, and it occurred, in fact, under accordingly great loss in substance of the pigment as well.

As further benefit of an invention-specifically doped pigment vis-á-vis merely coated pigments—for example according to the following Patent Specifications US-A 2004/0258610, US-A-2004/0250735, US-A-4375373, US-A4328040, US-A4125412, US-A-4447271, GB-A-2242420, GB-A-2252551, GB-A-2253893, EP-A-78633, EP-A409879 - one can name the possibility of subjecting the product after calcination to also mechanically demanding installation processes without significant increase in photo-activity. This represents another beneficial embodiment of the invention when required, but does not constitute, in principle, any necessity for its realization.

The invention-specific rutile pigment presents a multitude of benefits: It shows beneficial purity of color shade, low photo-activity and chemical compatibility with the respective application matrix, without the existing iron contents playing a significant role from a coloring or chemical aspect. No expensive chemical re-working is required according to the traditional sulfate or chloride processes in order to serve as raw material for a more intensively acting doping with nickel or chrome to mixed phase oxide pigments. As a result, the raw material situation for such pigments becomes more favorable. In addition, the invention-specific rutile pigment displays particularly beneficial brilliance, purity of color and cover potency with concurrent photo-activity that has been reduced to a minimum. After only low mixing expense, it is highly suitable for installation into only lightly tinted almost white polymer materials, construction materials, ceramic coatings, papers and laminate press substances, printer's colors, varnishes and paints.

The following reference is of importance with respect to the assessment of the invention:

Since the doping step proper, analogue the diffusion reactions and corresponding precursor reactions of the long known mixed phase metal oxide pigment chemistry is of only non-essential character for this invention, the following will provide only some exemplary and, therefore, the scope of the invention not limiting representations for a possible execution of the invention-specific method:

### EXAMPLE 1

### Production

1.1 The manufacture of the samples took respectively place on a scale which contained as starter quantities the element-mass ratios listed in the table of respectively 200-2000 grams of synrutile resulting from the ilmenite preparation process. After fine-grinding to approximately d₅₀=340 nm, this “precursor” is mixed with compounds of the doping elements in the required amounts in form of solution or suspension, then dried in the drying cabinet and calcinated in a muffle furnace at the stated temperatures for 60 minutes. Prior to manufacture of a preparation, the material is subjected to a brief dry-grinding process for purposes of desagglomeration.

1.2 Exemplary analysis of a ZnO-doped and calcinated synrutile-“pastel”-white pigment:

TABLE 1
(Synrutile, doped with 1% ZnO and calcinated at 900° C.)

| | | | | | |
|---|---|---|---|---|---|
| ZnO roasted | % | 1.0 | Fe as Fe₂O₃ | % | 1.0 |
| soluble ZnO 0.07 m HCl | % | 0.25 | Al as Al₂O₃ | % | 0.96 |
| soluble ZnO 37% HCl | % | 0.50 | Ca as CAO | % | 0.11 |
| soluble Ti 0.07 HCl | ppm | 20 | Cr as Cr₂O₃ | % | 0.15 |
| soluble Ti 37% HCl | % | 0.3 | Mg as MgO | % | 0.28 |
| roasting loss at 750° C./ | % | 0.04 | Mn as MnO₂ | % | <0.08 |
| 60 minutes | | | | | |
| roasting loss at 900° C./ | % | 0.04 | Si as SiO₂ | % | 0.90 |
| 60 minutes | | | | | |
| difference at 100% = TiO₂ | | | V as V₂O₅ | % | <0.09 |

Significant quantities of the doping elements can only be found if the sample is rendered soluble or if already significant quantities of the titanium are dissolved in the acid. This applies with respect to the “natural” doping levels (originating from residual impurities of the raw material) as well as the “subsequent” (intentionally entered) doping levels.

The products obtained for further testing are physically characterized as follows: (Table 2); they were selected from the multitude of samples produced during extensive research work because they were particularly representative types of pigments:

TABLE 2
(Invention-specific Doping Degree)

| | Analysis | | | Tempering | Doping |
|---|---|---|---|---|---|
| No. | % TiO₂ | % Fe | d₅₀ | (nm) (° C.) | (%) |
| 2-1 | 97 | 0.7 | | — | — |
| 2-2 | 97 | 0.7 | 400 | 900 | — (=“standard”) |
| 2-3 | 97 | 0.7 | 430 | 900 | 1.0 ZnO (compare |
| | | | | | Table 1) |
| 2-4 | 97 | 0.7 | | 900 | 1.0 CaO |
| 2-5 | 96 | 0.5 | 420 | — | — |
| 2-6 | 96 | 0.5 | | 900 | — |
| 2-7 | 96 | 0.5 | | 900 | 1.0 ZnO |
| 2-8 | 96 | 0.5 | | 900 | 1.0 CaO |
| 2-9 | 96 | 0.5 | 600 | 900 | 4.0 Al2O₃ |
| 2-10 | 96 | 0.5 | 620 | 900 | 0.2 SnO₂ + 3.8 Al₂O₃ |
| 2-11 | 96 | 0.5 | 530 | 900 | 1.0 Ce₂O₃ + 3 Al₂O₃ |
| 2-12 | 96 | 1.7 | | — | — |
| 2-13 | 96 | 1.7 | | 900 | — |
| 2-14 | 96 | 1.7 | | 900 | 1.0 ZnO |
| 2-15 | 96 | 1.7 | | 900 | 1.0 CaO |
| 2-16 | 99.7 | 0.0002 | | | industrial TiO₂ |
| | | | | | White Pigment |

Qualitative Evaluation: The respectively obtained pigment material is tinted pale-yellow and presents barely ascertainable photo-activity. Installation into PVC rolled films produces light yellow, pure color, opaquely tinted weather-stable and light-stable plastic substances.

Installation into HDPE results in likewise stable-colored extrusion plates in color tints which can be harmonized with the initially mentioned RAL-shades with only little pigment mixing and grinding expense (share of the “pastel-white pigment based on synrutile is respectively in excess of 95%).

### EXAMPLE 2

### Coloristic Assessment

To that end, paint sample specimens were first made for purposes of rapid weathering and long-term UV test, using the following method: (Table 3):

TABLE 3
(Preparation of Specimens)

| | | |
|---|---|---|
| 1.0 g | Pigment via IKA mill | |
| 4.0 g | BM ATA/LO93 | alkyde resin binder agent on Laropal basis |
| 10 g | 2 mm glass pearls | then 156 seconds mixing centrifuge |
| 5.0 g | BM ATA/LO93 | alkyde resin binder agent on Laropal basis |
| 3.0 g | hardener ATA/LO93 | then 52 seconds mixing centrifuge |

Notation:
0.50 mm black-white cardboard as substrate, 30 minutes venting, 30 minutes 80° C. hardening.

In each instance a measurement was taken of the color difference between a sample and an undoped but roasted very fine synrutile pigment (Sample No. 2-2)—which method was initially applied as an arbitrarily selected standard, but which offers very good opportunities for comparison; the relationship, in turn, between the standard itself and the standardized RAL-shade 1014 GL is quite clear. The pigment which was produced by simple grinding of a synrutile is respectively listed next to its variation which was only roasted and also its roasted and doped variation (Table 4):

TABLE 4
(Colorimetrical Assessment of the obtained Samples by Comparison)

| | Distance from Standard | | | Distance from RAL 1014 | | |
|---|---|---|---|---|---|---|
| No. | dL | dA | dB | dL | dA | dB |
| 4-1 | −4.2 | −2.6 | −6.3 | | | |
| 4-2 | | | =Standard | | | |
| | 0.0 | 0.0 | 0.0 | −2.0 | +2.0 | +4.1 |
| 4-3 | +0.7 | −0.7 | −1.9 | | | |
| 4-4 | −0.2 | −0.7 | −0.2 | | | |
| 4-5 | −1.7 | −3.4 | −6.5 | | | |
| 4-6 | +1.7 | −0.7 | −1.3 | | | |
| 4-7 | −1.7 | −3.5 | −6.6 | | | |
| 4-8 | +0.1 | −2.0 | −3.1 | | | |
| 4-9 | −0.2 | −1.1 | −1.7 | | | |
| 4-10 | −.02 | −0.3 | −0.3 | | | |
| 4-11 | +0.4 | −0.9 | −1.3 | | | |
| 4-12 | −0.4 | −0.6 | −3.0 | | | |
| 4-13 | −0.2 | +1.1 | +1.0 | | | |
| 4-14 | +0.1 | +0.1 | +0.3 | | | |
| 4-15 | =1.2 | −1.0 | −0.9 | | | |

| | |
|---|---|
| 4-16 | cannot be meaningfully presented according to measuring |
| | technique; color distances too great |

### EXAMPLE 3

### Photo-Activity and Constancy in Application

In addition to the color difference, testing was done in regard to the UV activity of the samples; because of the highly different application methods in actual practice, the UV-sensitivity was measured and assessed according to the following methods:

3.1 Color specimen according example 2 and 16 hour exposure to light of sample with simple 180W-/ 360nm-UV light exposure of a color sample with “HANAU-FLUOTESTER 5261”, measurement of color difference between exposed and non-exposed part of sample. The values dL, dA and dB (brightness, red-green deviation, yellow-blue deviation) are particularly instructive.

3.2 Rapid test according to Dupont (see above) slightly modified, 3 hour exposure at 35° C., measurement of Y-values (brightness) before and after exposure. The method (Braun, J. H.: “TiO₂'s Contribution to the Durability and Degradation of Paint Film—II. Prediction of Catalytic Activity”, J. Coatings Technology 62 (1990) No. 785, 37-42) is briefly described below since it was applied in modified version in this context:

A stock test dispersion is made of 139.2 grams of glycerine, 20.8 grams of Cab-O-Sil (pyrogenic SiO₂) and 100 grams of basic lead carbonate, said mixture is stirred for 8 hours at high stirring speed under reduced entry of air-oxygen; this stock dispersion keeps for approximately 10 months. 1.7 grams (0.9 ml) of same are made with 0.3 grams of the pigment sample into a dough and shaken with 3 glass balls for 2 minutes under dimmed light. One drop of the mixture or approximately 0.15 grams are placed on a glass slide—they are covered with a cover slide and by means of careful pressing distributed over the area of the cover slide, so that the view is cloudy when looking through the slide. In difference to the cited literature, exposure under the HANAU-FLUOTESTER 5261-lamp at 180W-/360 nm, at 35° C. lasted only 180 minutes. The differences which were noted here are, therefore, to be assessed as all the more significant. For their evaluation we are involving here only the delta Y value (brightness before and after exposure).

TABLE 5
(Photo activity while test sample exposed to light with exposure
of test sample and during the test according to Dupont
for comparison)

| | Light Exposure of | | | |
|---|---|---|---|---|
| | Specimen (16 hours) | | | |
| | UV | | | “Dupont Test” |
| No. | dL | dA | dB | 3 hours UV − ΔY |
| 5-1 | −1.8 | −0.4 | −3.0 | 27 |
| 5-2 | +0.3 | +0.5 | +0.5 | 0 |
| 5-3 | +0.1 | +0.5 | +0.5 | 0 |
| 5-4 | 0.0 | +0.5 | +0.5 | 2 |
| 5-5 | −2.0 | −0.2 | −1.8 | 34 |
| 5-6 | −1.0 | +0.1 | −0.9 | 0 |
| 5-7 | −0.6 | +0.4 | +0.1 | 0 |
| 5-8 | −0.6 | +0.7 | +0.3 | 1 |
| 5-9 | 0.0 | +0.7 | +0.4 | 0 |
| 5-10 | −0.3 | +0.4 | +0.1 | 0 |
| 5-11 | −0.3 | +0.5 | −0.2 | 0 |
| 5-12 | −2.5 | −2.2 | −7.2 | 28 |
| 5-13 | −0.3 | −1.0 | −1.9 | 0 |
| 5-14 | −0.2 | −1.6 | −3.2 | 0 |
| 5-15 | +0.4 | +0.4 | +0.5 | 0 |
| 5-16 | −0.3 | 0.0 | +1.4 | 26 |

The comparison data are shown before and after exposure to light.

3.3. Weathering test in ATLAS-1200 CPS “Xeno Tester” according to DIN EN ISO 11341:1998 with radiated output density of 55 W/m², UV filter 3×Suprax; wet-/dry cycle 18:102 minutes;—but shortened—ascertained color deviation and loss of brilliancy. Weathering test duration amounted to 1200 hours. Shown are the comparison data of the pure pigment as well as mixtures containing various organic pigments prior and after subjection to weathering test.

TABLE 6
(Photo-activity during light exposure of paint samples in “Xenotester”)
1200 hours Xenotester 55 W/m²

| | Δ Brightness start-finish | | | | | |
|---|---|---|---|---|---|---|
| | 20° | 60° | DL | Da | Db | DE |
| Purton | | | | | | |
| 6-2 | 13 | 5 | −0.5 | 0.0 | −0.2 | 0.5 |
| 6-3 | 10 | 5 | −0.4 | 0.2 | 0.5 | 0.7 |
| 6-16 | 7 | 3 | −0.5 | 0.0 | 0.0 | 0.5 |
| 10:1 C.I. PY 151 | | | | | | |
| 6-2 | 15 | 7 | 0.5 | 0.0 | −6.2 | 6.2 |
| 6-3 | 24 | 9 | −0.9 | 0.2 | −6.4 | 6.5 |
| 6-16 | 6 | 4 | 0.0 | 1.0 | −11.6 | 11.6 |
| 10:1 C.I. PR254 | | | | | | |
| 6-2 | 23 | 10 | 1.2 | −2.3 | −1.7 | 3.1 |
| 6-3 | 20 | 11 | 0.9 | −1.6 | −1.2 | 2.2 |
| 6-16 | 8 | 4 | 2.4 | −2.8 | −2.7 | 4.5 |
| 10:1 C.I. PG 7 | | | | | | |
| 6-2 | 24 | 11 | −0.7 | 1.6 | −0.3 | 1.8 |
| 6-3 | 13 | 13 | −0.8 | 1.9 | −0.3 | 2.1 |
| 6-16 | 7 | 3 | −0.7 | 1.6 | −0.2 | 1.8 |

Evaluation of the Results of Tables 5 and 6:

The photo-activity of the pigments which were doped and roasted according to the invention declines in comparison with the undoped pigment. Doping can be employed in order to adapt the color tint of the product in accordance with requirement. With respect to organic coloring substances, the photo-chemical reciprocal interactions remain minor.

Compared with traditional commercial white pigment, the invention-specific products are equivalent; the material now has exploitable pigment character. In follow-up tests, the shine of the invention-specific pigments could be increased and, as a side effect, the abrasiveness in the varnish matrix could further be decreased by applying different silane- and siloxane-based surface coatings onto the pigment.

### EXAMPLE 4

### Determining the Lightening Power in Coatings for Evaluation of Covering Capacity

Covering capacity was determined according to DIN 55 987 in an oxidatively drying alkyl varnish. For that purpose, 70 g of varnish, 30 g of pigment and 120 g of glass pearls (2 mm) were weighed and placed into a polypropylene beaker and then shaken for 20 minutes on a Scandex shaking device. The pigmented varnish was applied with the aid of a film pulling apparatus (Erichsen Model 509 MCIII) by means of a step ductor type 421/II also from the Erichsen Company in wet coating thicknesses of 60 to 400 μm onto black-white contrast cards. After the varnish film dried, the color shade difference DE was ascertained over black and white underground according to DIN 6174 and graphically recorded against the reciprocal value of the coating thickness. The coating thickness was ascertained from this with the color shade difference being DE=1.

The covering capacity in the following Figures is stated relative to titanium dioxide white. The concentration of the tested pigments lay below the critical pigment volume concentration (CPVK).

1. Method for the manufacture of a pastel-white, highly opaque, micro-particle rutile pigment from a crude rutile, synrutile or from a characteristic slag-like rutile-type precursor customarily used for production of titanium dioxide from processing of ilmenite into titanium dioxide, characterized in that the starter material in form of crude rutile, synrutile or the slag-like, rutile-type precursor is finely ground in several steps in high efficiency mills, which do not leave behind any significant metallic fines, down to a particle size of approximately 200 to 600 nm, whereby initially a dry preliminary grinding step is performed and thereafter with high recorded grinding output a wet grinding phase is performed during a final grinding step, the ground-down product dried and the obtained rutile pigment in finely distributed form calcinated at temperatures ranging between 790 and 1050° C.

2. Method according to claim 1, characterized in that the obtained rutile pigment is subjected to desagglomeration.

3. Method according to claim 1, characterized in that the starter material is ground down in high efficiency mills, which do not leave behind any staining or color-providing fines, to a fineness with average grain diameter, which lies maximally 10% below the average grain fineness of the end product.

4. Method according to claim 1, characterized in that during wet grinding for doping purposes a thermally decomposable reagent is added fully and/or partially as saline solution or as suspension, containing no solid of liquid residues—except for the doping elements .

5. Method according to claim 1, characterized in that the crude rutile is roasted in homogenized mixture with salts, hydroxides, and/or organic aggregates of its doping elements at sufficient length of time and temperature for the diffusion process.

6. Method according to claim 4, characterized in that one or several of the doping elements are applied prior to roasting onto the surface of the embossing pigment in a chemical precipitation step as one or several particle coatings.

7. Method according to claim 4, characterized in that the doping elements were used: tin, ceric, circonium, antimony, aluminum, boron, gallium, calcium, phosphorus, silicon and/or germanium.

8. Method according to claim 4, characterized in that the doping elements are used in such quantities that individually they do not amount to more than 10% by weight, in particular not more that 4% by weight of the final product.

9. Method according to claim 4, characterized in that by way of color-providing and color-intensifying as well as valency-equalizing doping elements the following are used nickel, niobium, chrome, vanadium, phosphorus, molybdenum, silicon, gallium, antimony and/or tungsten.

10. Method according to claim 1, characterized in that in the processing of synrutile as starter material, oxides, hydroxides, carbonates, nitrates, fluorides and/or sulfates are utilized of specifically zinc, calcium, aluminum, circonium, ceric, boron and/or silicon as deactivating or stabilizing substances.

11. Method according to claim 4, characterized in that the doping means are employed in finely distributed or suspended or in dissolved form.

12. Method according to claim 4, characterized in that the doping elements are applied as gel layer on the surface of the rutile particles.

13. Method according to claim 4, characterized in that for the manufacture of a rutile pigment from synrutile, 0.1 to 10% by weight of doping mass shares are used in order to neutralize the iron shares with respect to color.

14. Method according to claim 1, characterized in that calcination is performed relative to a synrutile as starter material in the presence of mineralizing, doping and color-providing additives.

15. Method according to claim 1, characterized in that calcination is performed during 10 to 270 minutes, especially during 15 to 90 minutes.

16. Pastel-white, highly opaque, micro-particle rutile pigment, obtainable according to claim 1, with reduced, grinding-stable photo-activity and a grain size distribution with particle diameters between 150 and 1 000 nm and with a mono- or oligo-modal frequency distribution with a principal maximum ranging between 300 and 600 nm.

17. Rutile pigment according to claim 16, characterized in that it has a grain size distribution with particle diameters ranging between approximately 250 and 1000 nm, in particular between 320 and 800 nm.

18. Rutile pigment according to claim 16, characterized in that it is doped with diffusing metal ions soluble in the rutile lattice, which photo-chemically deactivate the rutile.

19. Rutile pigment according to claim 16, characterized in that it has an iron contents of less than 5% by weight, especially 0.5 to 5% by weight.

20. Rutile pigment according to claim 16, characterized in that it contains doping elements in form of tin, ceric, circonium, zinc, antimony, aluminum, boron, gallium, calcium, phosphorus, silicon and/or germanium.

21. (canceled)
